(19) United States
(12) Patent Application Publication
(10) Pub. No.: US 2006/0168619 A1
(43) Pub. Date: Jul. 27, 2006

(54) Audio/video program-related hyperlink printer

(76) Inventor: David Anthony Reams, Madison Heights, MI (US)

Correspondence Address: David A. Reams, 601 E. Hudson Avenue, Madison Heights, MI, 48071, US

(21) Appl. No.: 11/318,713

(22) Filed: Dec. 27, 2005

Related U.S. Application Data
(63) Continuation-in-part of application No. 09/839,074, filed on Apr. 20, 2001.

(51) Int. Cl. H04N 5/445

(52) U.S. Cl. 725/38

(57) ABSTRACT

A system is disclosed for hyperlinking to printable content related to program material during the playing of the program material and printing the printable content comprising a generator for generating an hyperlink address string associated with the program material including a first attribute indicating an hyperlink address for hyperlinking to the printable content and a second attribute indicating certain temporal behavior for hyperlinking to the printable content, an encoder for encoding the hyperlink address string for transmission via a program signal transmitter, the program signal transmitter for transmitting the hyperlink address string, a program signal receiver for receiving the hyperlink address string, a data processor for processing the hyperlink address string, a web browser for hyperlinking to the printable content during the playing of the program material and a printer for printing the printable content based on the certain temporal behavior for hyperlinking indicated in the second attribute.

### CROSS REFERENCE TO RELATED APPLICATION

This application is a continuation-in-part application of U.S. patent application Ser. No. 09/839,074 filed Apr. 20, 2001, the disclosure of which is incorporated herein by reference.

### FIELD OF THE INVENTION

The invention relates to the field of distribution of coupons or other printable content associated with audio or video program material. In particular, the invention relates to the field of using the Internet to distribute coupons or other printable content associated with audio or video program material.

### BACKGROUND OF THE INVENTION

Vendors advertising in newspapers often provide coupons on merchandise for sale as enticements to draw members of the public into retail outlets. Said vendors, advertising or otherwise marketing merchandise in audio or video programs, may electronically distribute coupons via the program signals. Several prior art systems teach distributing coupons via interactive television. See, for example, Nemirofsky, U.S. Pat. No. 5,907,350, Jones, et al, U.S. Pat. No. 5,978,013, Walkingshaw, et al, U.S. Pat. No. 5,488,423 and Mankovitz, et al, U.S. Pat. No. 5,523,794, which are incorporated herein by reference.

Prior art systems fail to provide efficient means for said vendors to enter and/or transmit program-related coupon information. By transmitting the entire coupon itself via the television signal rather than, for example, just the URL to a web page to access the coupon, said prior art systems necessitate higher bandwidth or television data capacity to transmit and thereby incur greater cost.

Further, said prior art systems do not combine vendor coupon information entry and interactive television with the Internet to assist in entering and distributing coupon information. As demonstrated herein, web technology can facilitate such coupon information entry and distribution. Thus, a twofold problem with the prior art is excessive television data capacity and failure to employ the Internet to enhance vendor entry and distribution of program-related coupon information.

In addition, as described herein, an elaborate multimedia presentation language, Synchronized Multimedia Integration Language (“SMIL”), is used to reference extensive temporal, spatial and interactive attributes and values for hyperlinking to and presenting coupons and other printable content related to predetermined program material. Said attributes and values, however, are equally applicable for specifying how said coupons and other printable content should be printed. It would be beneficial to apply the same SMIL temporal, spatial and interactive attributes amd values used to specify hyperlinking to printable content to also specify printing of hyperlinked printable content.

“Program material” as used herin may be audio or video commercial, sports, news, entertainment or non-commercial program material. The term “coupon” is defined herein expansively as in Engel, et al, U.S. Pat. No. 5,907,830, which is incorporated herein by reference, to include any paper certificate used to obtain anything of interest to a potential consumer such as special pricing, a discount, money, samples or additional product, premiums, rebates or any other thing of value or interest. Other printable content that may be related to program material in the instant invention may be other supplemental information related to commercials, additional audio sound tracks or additional visual information including information about the characters, story-lines and background information related to the program, close-ups of specific items within the program material, alternative camera angles for video program material, alternative scenes and dialogue for characters, image triggers tied to particular images on screen such as a individual's face, articles of clothing or a can of soda linking to a web page containing information about an associated product or service and interactive prompts/sequences for the viewer to select.

The term “hyperlink”, as used herein, includes a link to retrieve and render Internet or locally stored content such as text, graphics, sound, video or images. Hyperlinking behavior is described as “seeking” the document wherein seeking in this sense means to advance the document timeline to the specified time as specified in http://www.w3.org/TR/2001/REC-smil-animation-20010904/, which is incorporated herein by reference. Said hyperlinking may require one or more user agents including a browser application and, to retrieve and render SVG content, an SVG user agent as specified in http://www.w3.org/TR/SVG/intro.html#Terminology, which is incorporated herein by reference. In addition, said hyperlinking may be activated in the instant invention by an actuate attribute or timing instructions contained in a timing attribute such as begin, dur, end, restart, repeatcount, repeatdur and fill or an event attribute without any actuate attribute. Said begin timing attribute may define when an element becomes active and said event attribute may have a value describing the event and an optional offset (for example, to account for any transmission time taken to fetch the content via hyperlink) that determine element begin time, any event being an user-interface event, an event trigger transmitted with the program signal or any other event specified in http://www.w3.org/TR/DOM-Level-2-Events/events.html#Events-eventgroupings, which is incorporated herein by reference. Further, the instant invention support interactive timing of animation elements to allow the author to specify that an animation should begin or end in response to an event (such as an user-input event like “click”), another hyperlink activation or a DOM method call to begin or end animation using the special value “indefinite” as specified in http://www.w3.org/TR/2001/REC-smil-animation-20010904/.

### SUMMARY AND OBJECTS OF THE INVENTION

The instant invention solves said twofold problem in prior art systems first by transmitting via the audio or audio program signal the URL to a web page having a coupon rather than the entire coupon (the web page content) itself. Second, the instant invention brings the vast resources of the World Wide Web to facilitate vendor entry of program-related coupon information and integrates program-related URL receiving with Internet access to hyperlink to a coupon web page.

One object of the invention is to transmit a coupon web page URL address rather than the coupon itself with a program signal.

Another object of the invention is to use the Internet to enhance coupon information entry and distribution in interactive television/radio systems.

A related object of the invention is to deploy a website for vendor entry of program-related coupon information and generating a coupon URL string.

Another object of the invention is to connect television viewers and radio listeners to a web page to access a program-related coupon.

Yet another object of the invention is to extend SMIL's temporal, spatial and interactive attributes for hyperlinking to predetermined printable content related to predetermined program material to also specify the printing of the predetermined printable content.

Additional objects will be apparent from the following detailed description.

### BRIEF DESCRIPTION OF THE DRAWINGS

The features and advantages of the present invention can be understood by reference to the detailed description of the preferred embodiments set forth below taken with the drawings, in which:

FIG. 1 is the system of the present invention.

FIG. 2 shows one SMIL URL STRING that may be generated by the present invention.

FIG. 3 shows another SMIL URL STRING that may be generated by the present invention.

### DETAILED DESCRIPTION OF THE INVENTION

The invention disclosed herein comprises a system for generating an hyperlink address string associated with predetermined program material related to predetermined printable content including attributes and values for hyperlinking to said predetermined printable content and hyperlinking to said predetermined printable content during the playing of said predetermined program material wherein said attributes and values for hyperlinking are also used as attributes and values for printing comprising generating means for generating said hyperlink address string associated with said predetermined program material including a first attribute indicating a predetermined hyperlink address for hyperlinking to said predetermined printable content and a second attribute indicating predetermined temporal behavior for said hyperlinking, encoding means operably coupled to said generating means for encoding said hyperlink address string for transmission via program signal transmitting means, said program signal transmitting means operably coupled to said encoding means for transmitting said hyperlink address string, program signal receiving means operably coupled to said program signal transmitting means for receiving said hyperlink address string, data processing means operably coupled to said program signal receiving means for processing said hyperlink address string in predetermined manner, hyperlink means operably coupled to said data processing means for hyperlinking to said predetermined printable content during the playing of said predetermined program material and printing means operably coupled to said data processing means for printing said predetermined printable content based on said predetermined temporal behavior for said hyperlinking indicated in said second attribute.

Said hyperlink address string may include one or more additional attributes indicating a spatial and/or an interactive aspect of said hyperlinking. Said predetermined printable content may comprise a multimedia document with at least on of the following components: text, image, animation, video, streaming video or audio converted to image or text. Said predetermined printable content may be printed out to a file or hard copy. Further, said predetermined printable content may comprise a coupon or any other hyperlinked printable content that may be related to said predetermined program material.

The presentation of the multimedia message is controlled by SMIL (Synchronized Multimedia Integration Language), which is a mark-up language akin to HTML (Hyper-text Mark-up Language) and XML (Extensible Mark-up Language). SMIL presentation is a mandatory component of the multimedia messages. The SMIL is used for programming even complex multimedia presentations to be composed and presented to the end user. SMIL defines a structure for the presentation comprising a multimedia files, which can be text, sound, images, video, animation, etc. or a combination thereof. Layout of a SMIL-presentation is divided into different regions, each of which can be contained of different multimedia content. The structure resembles that of a slide presentation application or similar presentations. The SMIL presentations contain spatial aspects (e.g. where an image is located on the display), temporal aspects (e.g. how long an image is visible on its location) and interaction aspects (e.g. by actuation of which key an image becomes visible or other automatic hyperlink activation event).

The need for printing images related to received program material via is increasing. The service suppliers offer general printing services, such as photo kiosks for printing them. The user sends the image through MMS to the service supplier who prints it to the paper. When the paper photos are ready the service supplier informs the customer e.g. by SMS that the photos are ready/available to be picked up. If the presentations are rendered to a fixed, unalterable surface, e.g. printed to the paper, some of the presentation components are not applicable, especially those that control the temporal and interaction aspects of the presentation. This problem arises also if one wants to print out a multimedia message. The problems to be solved are how the necessary information is extracted from the message and how the images are placed into the print.

One aspect of the current invention is to form at least one printable output, such as a variable-sized paper, a postcard, a facsimile, from an electronic presentation, e.g. multimedia message, comprising at least one event. An “event” in this description corresponds to a time the object appears in the presentation, in other words, an onset of the object. A term “object” refers to any multimedia element being delivered in a program signal carrying multimedia elements. Multimedia element can be an image element, a text element, an interaction element, a video element, an audio element etc.

The printable output can be formed by defining a temporal aspect of said at least one event, whereby said printable output comprising said event, is formed based on that definition. This means that the electronic presentation is analyzed in time, whereby as many events there are (multimedia) objects in the message are analyzed.

Additional feature of the current invention is to study a spatial aspect of each event by defining the location of the event in relation to the layout of the presentation and then combine events into one output, if their layout locations differ from another, and otherwise keep them on separate outputs. The events locating substantially on the same layout location are further studied by their temporal aspect, and that event, which is temporally closer—than those other events sharing the same layout location—to the combined events is also added to the combined output. Sometimes, if the location of the objects matches, but the space required by the objects differs, wherein the objects are partially overlapping, further study may be done. In this case the temporal study, as mentioned above, can be done, wherein the temporally closer object is combined. It is also possible to combine the temporally further but bigger object.

The printed output, referred as printout, can be a paper printout or a file printout. The layout of one output can be formed similarly to the presentation and scaled to the size of the printout. Several outputs may be on one or many printouts.

The invention relates to a method for printing an electronic presentation, a device for use in a printing of an electronic presentation as well as a system for printing of an electronic presentation. The invention relates also to components for forming at least one printable output from an electronic presentation, components such as a device module and a computer program product. In addition the invention relates to a method for delivering a print of an electronic presentation to a recipient.

The description mentions electronic presentation as an embodiment of the invention. Electronic presentation can be a multimedia message or other multimedia presentation being processed in a mobile device or in other data processing device coupled to a program signal receiver apparatus and being composed of different multimedia elements. The electronic presentation is not limited to media types (image, text, video, audio).

Electronic presentation such as multimedia messages (e.g. SMIL presentation) with spatial, temporal and interaction aspects may not create same presentation when printed. The way how spatial aspects in the presentations are converted to printed surface may also be confusing to the end-user. However having a set of clear rules how a presentation is rendered to a printed page enables manufacturers to optimize products and guide end-users especially in case when messages are created specifically for printing services. The current invention is for presenting these rules.

This invention is primarily addressed to the electronic presentation, and to the mark-up language used in such. The description discusses about multimedia messages as examples of the electronic presentation, but it should be noticed that multimedia messaging (MMS) is a way of transferring presentations between devices wirelessly, and the invention is not limited to that transfer method. Printable outputs of electronic messages can be formed in a mobile device but also in some other data processing device, and they can be printed though a wireless network, through a cable, through a personal computer or through any other link to the printing device. It should be also noticed, that outputs can temporally be also printed only to file stored in some memory means.

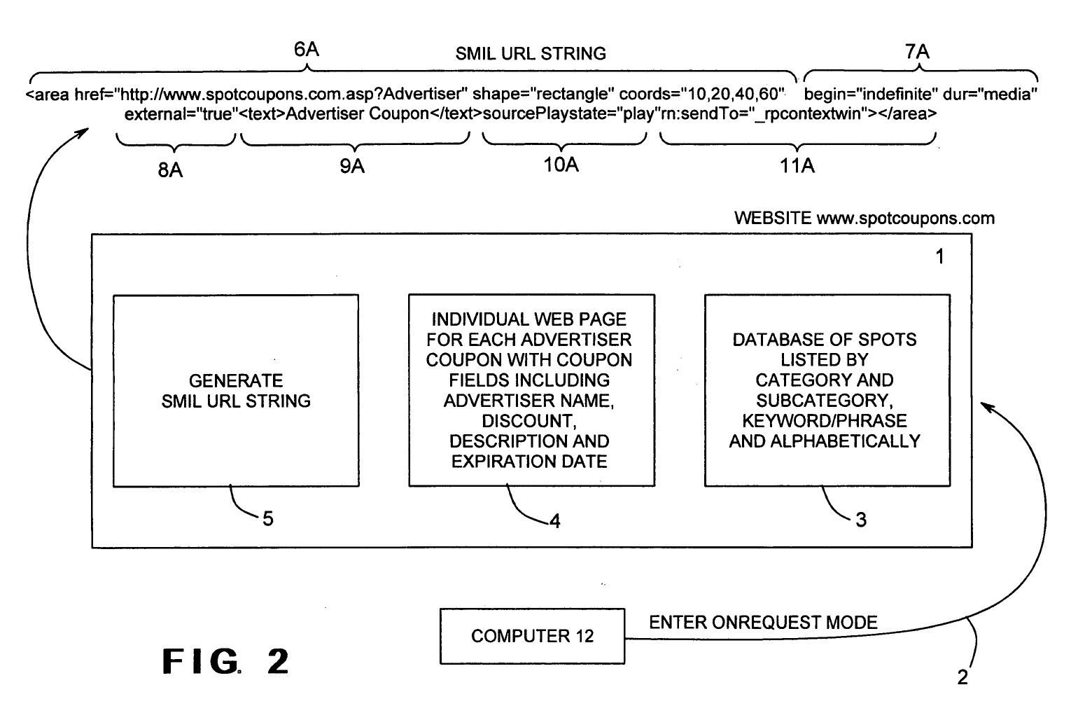

An example of mark-up language used in multimedia messaging (e.g. 3GPP) is SMIL 2.0, but it should be noticed that the mark-up language can be newer versions of SMIL or some other mark-up language, that has similar features than discussed here. FIG. 2 illustrates the basic structure of an electronic message, which is similar to the basic structure of SMIL presentation. Similar to the HTML or XML, SMIL uses tags where the information of the presentation is set. The <layout> element consists information about the presentation and presents <root layout> which defines how the presentation is showed on the display and what is the size of the layout. The layout locations, as regions (shown in FIG. 2) R1-R3 define where in the root the presentation objects actually occur. The description of the region is made by attributes of which <id> is the identification of the region, <title> gives information about the region, <left>, <top>, <width> and <height> define the location of the region compared to the root. It is obvious that presentation is not limited to three regions R1-R3, as well as the invention is not limited to three regions R1-R3. Above-mentioned regions R1-R3 are for the sake of clarifying.

The display program may include a part defining, for example, a plurality of display areas to perform the layout of each of the defined display areas, and a part or portion defining external information sources the information from which is severally displayed in the defined display areas and attaching other information to the defined display areas. As a result, since the displaying of the information from a specific external information source can be defined, it is possible to perform the layout of the information from the external information sources freely on the display screen by means of the rules of the URI.

For example, a plurality of display areas specified by defining the display areas as having attribute values “r1” and so forth by means of the element names “region” and the attribute names “id” in the elements. An external information source the information from which is displayed in each region defined by the above-mentioned region element can be specified by the URI. For example, by means of a schema “videoinput”, the external information source can be specified by the description following the schema “videoinput”. It also becomes possible to perform the control of apparatus such as the picture control, the contrast control and the like of the display screen by utilizing the animation function of the SMIL such as a dynamic change of the color of graphics, a movement of graphics by means of “?”. However, it is possible to utilize all of the reserved matters within request for comments (RFC): 2396 for defining a URI specifying an address on the Internet to be used in SMIL data, by using “?” only, which just happens to be reserved on the URI.

In addition, display program data can be stored as the display program data of the image information and the like which is subjected to several kinds of screen layouts. The display program data can be stored also in, for example a magnetic disk, a compact disk read only memory (CD-ROM) and the like. Furthermore, the display program data can be recorded in the other memories of the main body of the control unit 6 and external memories. As a result, the display program may have a variety of applications, and screen layouts become possible to realize in conformity with client apparatuses.

The <body> tag in SMIL contains the presentation objects in more detail, e.g. a media type of the object. The media types are <text>, <img>, <audio>, <video>. For the objects further details such as the “region”, “src”, “type” and “dur” are provided. “Region” defines the region in the message layout, where the object is shown, “type” defines the media type (for example MIME-type) for the object, “src” defines the source (e.g. URL) and “dur” defines the duration of the presentation. For example, <img region=“Region 1” src=“images/image1.gif type=“image/gif” dur=“10s”/> describes that image1 (media type is image) is shown in the Region1 for 10 seconds. It should be noticed that in the description only the images are discussed as media types, but in real situation objects can be any media such as text, image, video, and audio.

At first when forming a printable output from the electronic presentation according to the invention, the irrelevant, those that cannot be printed, objects e.g. interaction elements as well as those relevant multimedia elements which are rendered as a result of interaction are removed from the presentation. Other multimedia elements (e.g. sound media) can also be removed, if they do not have corresponding printable version or if they are just not wanted to be left. But it should be noted that e.g. sound file can be converted into a text- or an image-file, especially when the sound file is known sound such as ring.wav or cuckoo.wav or the tag has information of the sound (e.g. boo.wav ALT=“Scared?”). The sound files can be replaced e.g. by defining the conditions for it. The condition can, for example, be defined by a switch-sentence: 1<switch><audio src=“cuckoo.wav” device=“mobile”/><img src=“bird.gif” device=“printer”/></switch>, where it is first checked whether the device supports audio-files and, if not, the element is changed into a picture of bird.

Continuous or streamed media (e.g. animation or video) can be converted to non-continuous media when applicable, or removed. The conversion can be made for example by choosing one (first, last or one between) video frame and converting it. In embodiment of the invention disclosed herein, a Fill Button on the apparatus claimed herein enables an user to activate such freeze to print the image.

When the presentation is “cleaned”, temporal aspects of the presentation may be studied by means of a time axis representing events of the message in time t. At the beginning (t=1) only the first image IM1 may be displayed in the message. Next (t=2), the second image IM2 may be displayed in the same region as the first image, the first image IM1 not shown. After this (t=3), the third image IM3 may be displayed with the second image IM2 and then (t=) the fourth image IM4 may be displayed with the third IM3 and the second image IM2, because they all IM3, IM4, IM2 use different regions. FIGS. 4a-4d represent the phases of the displays. A first image IM1 may be displayed in region R1 (3a), a second image IM2 may be displayed also in region R1 (3b), the first image not shown anymore. A third image IM3 may be displayed in region R2 (3c) and a fourth image IM4 may be displayed in region R3 (3d). Each temporal event (appearance of an object) on time axis creates a new printable output and each formed printable output consists of one temporal event.

When the time axis analysis is done, the resulting events may be studied. All events without spatial overlap (e.g. overlap of two images) can be combined into same output. The first and second events IM1, IM2 cannot be combined, since they use the same region R1. They need to be printed separately. The third and the fourth events IM3, IM4 may be combined into same output, since they have images in different regions R2, R3. The second and the combined last events may be combined, since they use different regions for the images. The reason why the first event is not combined with the last events is because it is temporally further to them than the second one, the combination does not necessarily need temporally closer events. Depending on the situation, the combined event can be chosen.

The resulting one or many printable outputs (combined/separated) may then be printed. Printing is done, depending on a print device and a use, as multiple printouts or as a single printout. The multiple outputs can be scaled to fit adjacent slots in the printout, single output can be scaled to fill the printout or outputs can be printed as they are. It is obvious that the invention discussed here is not limited to printing, the outputs can be printed in any possible way.

The above-discussed method according to the invention can be applied also to lower versions of SMIL. As an example of such version is MMS SMIL or other relevant Open Mobile Alliance (OMA) standard messages or other corresponding multimedia messages, which are comprised of “slides”. At first the MMS message to be printed is analyzed and the irrelevant elements for printing (sometimes e.g. AMR- or MIDI-sound; MMS streaming elements) can be removed. The video objects can be converted to image objects (e.g. GIF, JPEG) of the same frame size. The selection of which frame is converted varies depending on the situation. The first or the last frame can be converted, but also any frame, or any set/combination of frames between them can be converted. Also it is possible to convert frames for example in every minute or in any other time interval. The originator of the message may define the frames that are preferably used for converting. The converted video images are from then on processed as images. Each slide of MMS SMIL presentation can be considered to be one event as in the 3GPP SMIL, and each results in new printable output. Since MMS SMIL defines only one image and text region, all images and texts are fully spatially overlapping. Thus the page combination may not be done. Due to this, the slides of MMS SMIL presentation will be printed either into/to multiple printouts or as adjacent slots in a single printout, depending on the use and the print device.

The method according to the invention is carried out by a computer program in an electronic device. The electronic device is, for example, a mobile device with communication capabilities. The device can be a mobile phone, communicator, PDA (portable digital assistant) or similar comprising also means, e.g. a display D, for reading/viewing the message. The mobile device can also have other features as well, e.g. a digital camera.

It should be noticed that while newer version (e.g. 3GPP SMIL) of MMS SMIL emerge to market, there will be a question about the interoperability between it and the MMS SMIL. As discussed before the basic difference between them is the difference of presentation model and profile. The MMS SMIL, for example, introduces a particular presentation of model “slideshow” which divides the presentation into a series of consecutive slides, each slide containing one image and one text and one audio. The slides define the necessary SMIL elements to realize the presentation model. On the contrary, 3GPP SMIL is a genuine profile which does not imply particular presentation model, but unlimited number of different presentations and variations may occur, including the one defined by MMS SMIL.

The current invention enables that the printable output forms a slide of a slide presentation, wherein it can applied in the conversion of 3GPP SMIL to MMS SMIL. Naturally one printable output forms one slide and many printable outputs form many slides. While considering the conversion of 3GPP SMIL to MMS SMIL it will be clear that exactly same presentation may not result, which can be considered a similar problem than with aforementioned printing of multimedia messages. However, the 3GPP SMIL presentation that is printed according to the invention, is possible to convert to the MMS SMIL presentation using the following additional steps:

a) consider each output 3GPP SMIL page as one MMS SMIL slide

b) convert all images and other media to one single image on each slide

c) construct MMS SMIL presentation based on the created slides.

### I. String Generation

Said hyperlink address string may comprise an URL string and said predetermined hyperlink address may comprise an URL. In addition or alternatively, said hyperlink address string may comprise an URI string and said predetermined hyperlink address may comprise an URI as defined in http://www.ietf.org/rfc/rfc3986.txt, which is incorporated herein by reference. Said generating means may comprise a website. Said automatic activating attribute may comprise an hyperlink automatic load attribute. Said automatic activating attribute may comprise an hyperlink start time attribute. Said system may further include the step of: encoding said hyperlink address string for transmission with program signals representative of said predetermined program material. Said hyperlink address string may further include an attribute instructing a predetermined time to deactivate said hyperlink to said predetermined hyperlink address.

Said URL string may be generated for VBI, Line 21 (“Transport Type A”) and resource data and trigger (“Transport Type B”) transmission using the EIA-746A standard as specified in Electronic Industries Association EIA-746A, “Transport of Internet Uniform Resource Locator (URL) Information Using Text-2 (T-2) Service” (September 1998), which is incorporated herein by reference. Said EIA-746A standard provides both television operators and receiver manufacturers a common means for delivering URLs associated with a commercial or other program, using the same television transmit channel used for closed captioning, thereby making said URLs available virtually everywhere television programming is received and enabling the use of closed captioning tools to encode and broadcast the URLs. The system disclosed herein supports both Transport Type A and Transport Type B triggers.

Referring to the Drawing FIG. 2, TELEVISION FACILITY COMPUTER 12 may access WEBSITE 1 via PUBLIC/PRIVATE LINK 2, which may be the public switched telephone network, an integrated digital network or similar wire or wireless facility, to encode an advertisement with an URL string including an URL to a web page having at least one coupon related to said advertisement and text identifying said at least one coupon. While the Drawing and system description herein are substantially specific to television facilities, it is understood that such specification is for illustrative purposes only and the Drawing and system description apply equally to broadcast, cable, satellite and Internet television and radio facilities and any video or audio recording medium.

Via WEBSITE 1 data entering means TELEVISION FACILITY may search DATABASE 3 of advertisements (“spots”) and associated URLs to coupon web pages (each located as INDIVIDUAL WEB PAGE 4 at WEBSITE 1 or at the advertiser website) to select a spot scheduled to be advertised. Said spots and associated URLs may be listed in DATABASE 3 by predetermined category such as media market and predetermined subcategory such as product/service, key word/phrase and alphabetically. When a spot is selected, the associated URL to the web page having at least one advertiser coupon may be automatically entered in said URL string and the text “[Advertiser Name] Coupon”, using the selected advertiser name, may be automatically generated in said URL string as said text identifying said at least one coupon related to said advertisement. TELEVISION FACILITY may alternatively directly enter via said data entering means a spot of interest and/or an associated URL to a web page having at least one advertiser coupon and said text identifying said at least one coupon related to said advertisement without selecting said spot from DATABASE 3.

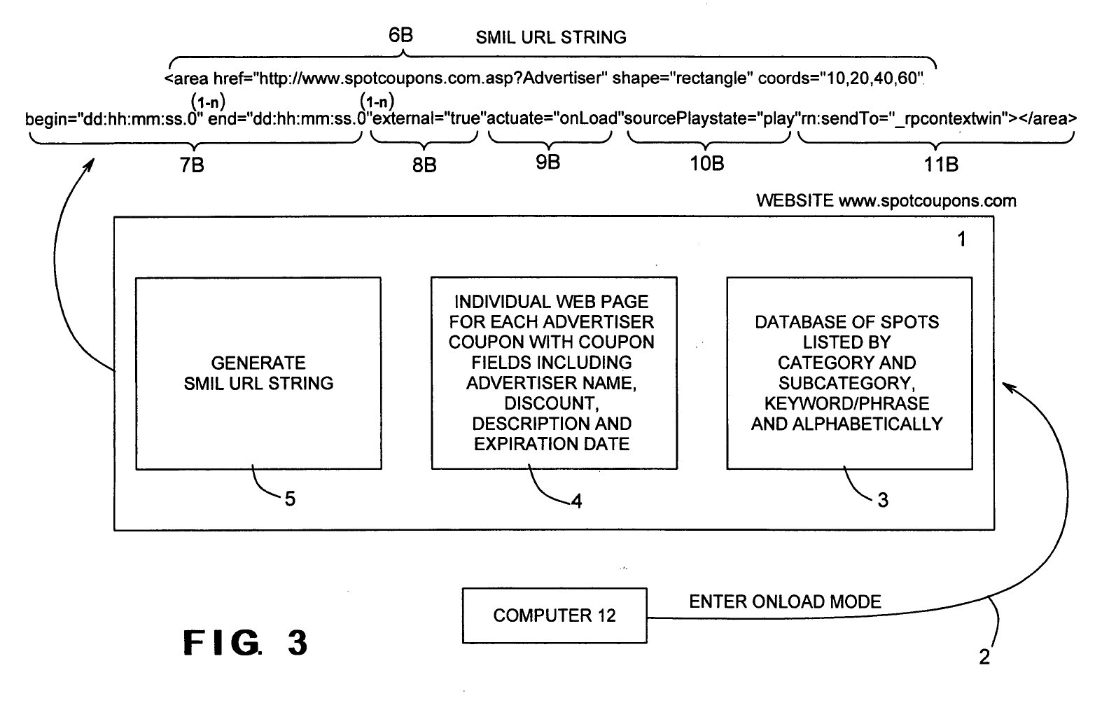

Referring to the Drawings FIG. 2 and FIG. 3, said system may further include the step of entering 2 via data entering means to database means operably coupled to said generating means: said predetermined hyperlink address and predetermined hyperlink activation data for said user-activated, ONREQUEST, or automatically, ONLOAD, activating said hyperlink to said predetermined hyperlink address including: predetermined user-activation data for said user-activating said hyperlink to said predetermined hyperlink address or predetermined automatic activation data for said automatically activating said hyperlink to said predetermined hyperlink address.

The URL STRING described herein may utilize the international Synchronized Multimedia Integration Language (SMIL) standard specified in http://www.w3.org/TR/SMIL2/, which is incorporated herein by reference. SMIL is an XML-based language, a “presentation description language”, that allows authors to write interactive multimedia presentations. While one embodiment of the invention is described utilizing the SMIL format, the media objects may be implemented in any other format such as any JPEG format, any Graphics Interchange Format (GIF), audio or digital audio formats, Audio IFF, Computer Graphics Metafile, TIFF, BIFF, bmp, Clear, FITS, NFF, OFF, PCX, PNG, TGA, XBM, mod, any Moving Picture Experts Group (MPEG) format, Musical Instrument Digital Interface, PICT, PNG, Portable Document Format (PDF), Portable Network Graphics, Portable Pixmap, progressive coding, Quicktime, RIFF, Self Extracting Archive, sequential coding; server-parsed HTML, sprite, Tagged Image File Format, targa, Targa Graphics Adaptor, thumbnail, wav, WebCGM, wireless bitmap, xpm or a different frame rate video.

Using SMIL, an author can describe the temporal behavior of a multimedia presentation, associate hyperlinks with multimedia objects and describe the layout of the presentation on a screen. Further, using SMIL media components may be named for text, images, audio and video with URL's to schedule their presentation either in parallel or in sequence. The presentation may be composed of several components that are accessible via the URL's, e.g. files stored on a web server, each having a different media type such as audio, video, image or text with the begin and end times of different components specified relative to events in other media components and the presentation links to components via hyperlinks. Supplemental multimedia information may also be accessed via hyperlinks to locally stored files which may have been pre-fetched and are stored at lid URL addresses. In addition to HDTV, High Definition (HD) Radio may use SMIL for multimedia encoding, transmission and receiver processing pursuant to http://www.ibiquity.com/technology/documents/SY_AAS_{—}5033_{—}002.pdf, the HD Radio-SMIL specification.

URL <a or <area href/shape and coords attributes. To enter the appropriate href attribute, an advertiser first selects the media being used to transmit the spot, HD Radio <a href, HDTV <area href or Media Player Audio <a href or Video <area href. The value of the href attribute the URL of the link's destination, may be automatically entered in SMIL URL STRING once entered as an advertiser's URL to WEB PAGE 36. While the <a href element associates a link, href attribute, with a complete media object, the <area href element using the shape and coords attributes associates the link with spatial portion(s) of an object's visual display. In addition, the area element allows breaking up an object into temporal subparts using begin and end attributes. Area (and a) element attributes include actuate, shape, coords, href, begin, end, dur, sourcePlaystate and external. Pursuant to said HD Radio-SMIL specification, HD Radio is to utilize only the <a href element to reference an URL link because the <area> element implies a display which can be partitioned. Since there is no shape or coords attributes associated with the <a href URL attribute, the shape and coords attributes are not included in the SMIL URL String <a href attribute.

The shape attribute specifies the shape of the hyperlink display with the values of rectangle shape=“rectangle”, circle shape=“circle” or polygon shape=“polygon”. The coords attribute specifies the relative position of the hyperlink display on the screen and include the following values: coords=“0,0,50,50” (Upper Left), coords=“50,0,100,50” (Upper Right), coords=“0,50,50,100” (Lower Left), coords=“50,50,100,100” (Lower Right), coords=“25,25,75,75” (Center) and coords=“10,20,40,60” (Lower Center).

Selecting the Media Element/Attribute Value automatically enters the respective <a or <area href attribute: HD Radio <a href, HDTV <area href, Media Player and Audio <a href or Video <area href. For example, the <area href attribute may comprise:

<area href=http://www.spotcoupons.com.asp?Advertiser shape=“rectangle” coords=“10,20,40,60” 6A/B.

Timing attributes begin, end and dur. To enter the appropriate timing attributes, an advertiser first must enter 2 the desired URL hyperlink activation mode, user-activated (ONREQUEST) begin=“indefinite” dur=“media” 7A or automatically activated (ONLOAD) begin=“dd:hh:mm:ss.0¹⁻ⁿ” and end=“dd:hh:mm:ss.0¹⁻ⁿ” 7B, day, hour, month, second, fraction of second start/end times scheduled, for example, in 1−n spots in an advertising campaign. The value of “indefinite” for the begin attribute signals that the beginning of the element is determined by user hyperlink activation during the playing of associated program material and the dur attribute value of “media” that the duration is the media duration. Another value for the dur attribute may be a clock value. If there is more than one begin and end value, such as to specify the start and end date/times in several spots scheduled to run in a television or radio advertising campaign, the next begin time is always the earliest begin time after the current time as determined by SMIL player clock and each respective begin and end value is separated by a semi-colon (;). Time values to begin and to end are relative to the beginning of the associated media object, i.e. television spot having related coupon web page for viewers to access. There is no need for month and year date codes in the begin and end time attributes because, since the time is measured from the most recent time as determined by SMIL player clock, the month and year can be determined from the clock internally. As an example, for 5 spots in ad campaign (n=5) with the respective start and end date/times as indicated in the first 5 date/time drop-down menus (for 5 respective begin/end attribute/value pairs in the SMIL URL String):

[image]

[image]

Timing attributes and timeline data structure used in SMIL for hyperlinking to predetermined printable content related to predetermined program material may also be used for, and indeed essential to, ensuring predictable behavior during printing of said content. For example, an advertiser may want to specify that printing of a spot-related coupon only take place while the hyperlink is available, e.g. between the SMIL begin and end or par values, or even immediately after the ad plays, e.g. pursuant to the SMIL seq time value. The SMIL dur value indicating the time value an object is to remain active could also indicate the same value for object printing. SMIL repeatCount and repeatdur indicating respectively the number of time and total amount of time an object will repeat could apply equally to object printing.

SMIL spatial attributes, for example, the layout location of each event, would likewise be of relevance to printing. The SMIL capacity attribute, switch, would certainly be relevant to printer capacity as well.

External/Internal attribute. The external attribute defines whether or not the link destination is opened by a current or an external application. Values for this attribute may be true, signaling to open by a browser application, or false, to open by the current application, which is the default value for the external attribute, for example external=“true” 8A/B. The internal attribute defines whether or not the hyperlink is to another node in the same SMIL presentation or local memory with values of true or false. In one embodiment disclosed herein, the apparatus may have a local, e.g. lid URL, hyperlink only so that apparatus does not comprise Internet web browser means and web page content may be transmitted in hyperlink address string or in advance of the hyperlink address string transmission (“prefetched”) via the SMIL Prefetch Element (using the mediaSize attribute to define a relative amount of the object to prefetch, mediaTime attribute to define a relative amount of time to dedicate to prefetching and a bandwidth attribute defining the relative amount of bandwidth to dedicate to prefetching).

Actuate attribute. The URL hyperlink activation mode may be selected and entered 2 as either user-activated (ONREQUEST) or automatically activated (ONLOAD). If the ONREQUEST (user-activated) hyperlink activation mode is entered, which is the default value for this attribute, the value of the actuate attribute may be <text>Advertiser Coupon</text> 9A or, if the ONLOAD (automatic) hyperlink activation mode is entered, the value may be actuate=“onLoad”9B. The CompanyName text may be automatically entered in the SMIL URL STRING text field upon user selection of the ONREQUEST hyperlink activation mode. Further, the attribute value actuate=“onLoad” 9B may be automatically entered in the SMIL URL STRING upon user selection of the ONLOAD hyperlink activation mode. Unless actuate=“onLoad” 9B is entered, the default value for the actuate attribute is actuate=“on Request”, which on Request value as the default does not need to be specified expressly to indirectly specifiy or indicate user-activated hyperlink activation and instead <text>Advertiser Coupon</text> 9A may be entered to display text to prompt user hyperlink activation, for example for ONREQUEST <text>Advertiser Coupon</text> 9A and for ONLOAD actuate=“on Load” 9B.

SourcePlaystate attribute. The sourcePlaystate attribute controls temporal behavior of the presentation containing the link when traversed. This attribute has 3 possible values: play, indicating when the link is traversed, the presentation containing the link continues playing; pause, when the link is traversed, the presentation containing the link pauses (to resume playing when the resource is completed) or stop when the link is traversed, the presentation containing the link stops without any resumption. An example of this attribute is sourcePlaystate=“play” 10 A/B

rn:sendTo attribute. The m:sendTo attribute may have _osdefaultbrowser, _rpbrowser or _rpcontextwin values. The _rpcontextwin value sets when the related info pane opens and may be openAtStart or auto (default). Additional attributes that may be coded in said URL string include [s:string] (NOT SHOWN), a script attribute, [showPIP:true] (NOT SHOWN) so a picture-in-picture video appears in a target web page on WebTV.TM. Receiver. Values for this attribute may comprise for PC Browser rn:sendTo=“_osdefaultbrowser”, Media Player Browser rn:sendTo=“_rpbrowserwin, Media Player Window in RealOne Player manufactured by Real Networks, Inc., Seattle, Wash. rn:sendTo=“_rpengine” or Video Screen Window rn:sendTo=”_rpcontextwin”> 11A/B.

In one preferred embodiment disclosed herein said data entering means and generating means may comprise website means, i.e. WEBSITE 1. Alternatively, said data entering means and generating means may comprise computer means, i.e. COMPUTER 12. WEBSITE 1 may then output said URL string to either AUDIO FREQUENCY ENCODING DEVICE 16 to encode said URL string for transmission via program audio channel data transmission means or download said URL string to program signal transmitting means. AUDIO FREQUENCY ENCODING DEVICE 16 may inaudibly embed said URL string in the program audio itself Audio frequency encoded data signals may then be fed from AUDIO FREQUENCY ENCODING DEVICE 16 to RECORDER 17 and onto STORAGE MEDIUM 18, or, alternatively, sent through AUDIO TRANSMISSION LINK 19 (such as a network program distribution system) to MIXER 15 located at TELEVISION FACILITY to be mixed in with program audio signals. STORAGE MEDIUM 18 may be sent to TELEVISION FACILITY for later playback via PLAYBACK DEVICE 20. Said URL string may be downloaded via PUBLIC/PRIVATE LINK 4 to TELEVISION FACILITY to be processed and transmitted via TELEVISION DATA TRANSMISSION LINK 21 at appropriate times in conjunction with transmission of associated program signals. Downloaded via PUBLIC/PRIVATE LINK 4, COMPUTER 12 may then output said URL string to DATA ENCODING DEVICE 13 to encode said URL string for transmission via conventional program data channel means such as VBI, MPEG, subcarrier, etc. In the alternative, COMPUTER 12 may output said URL string to DATA ENCODING DEVICE 14 to encode said URL string for transmission via program audio channel means (i.e. embedding in program audio signals via MIXER 15). In one preferred embodiment herein said URL string for television programs may be encoded for transmission via VBI, Line 21 pursuant to said EIA-746A standard.

String design using SMIL is case sensitive and must always be lower case except if multiple words are combined in one where the first letter of any word(s) after the first word is upper case. An example of HTML code for generating the SMIL URL STRING is contained in APPENDIX, which is incorporated herein by reference.

### II. Apparatus

The apparatus claimed herein is tied to and dependant upon said data entering means and generating means. Indeed, said apparatus is dependant on said data entering and generating means to receive a program-related coupon web page URL and temporal attribute values for hyperlinking and printing.

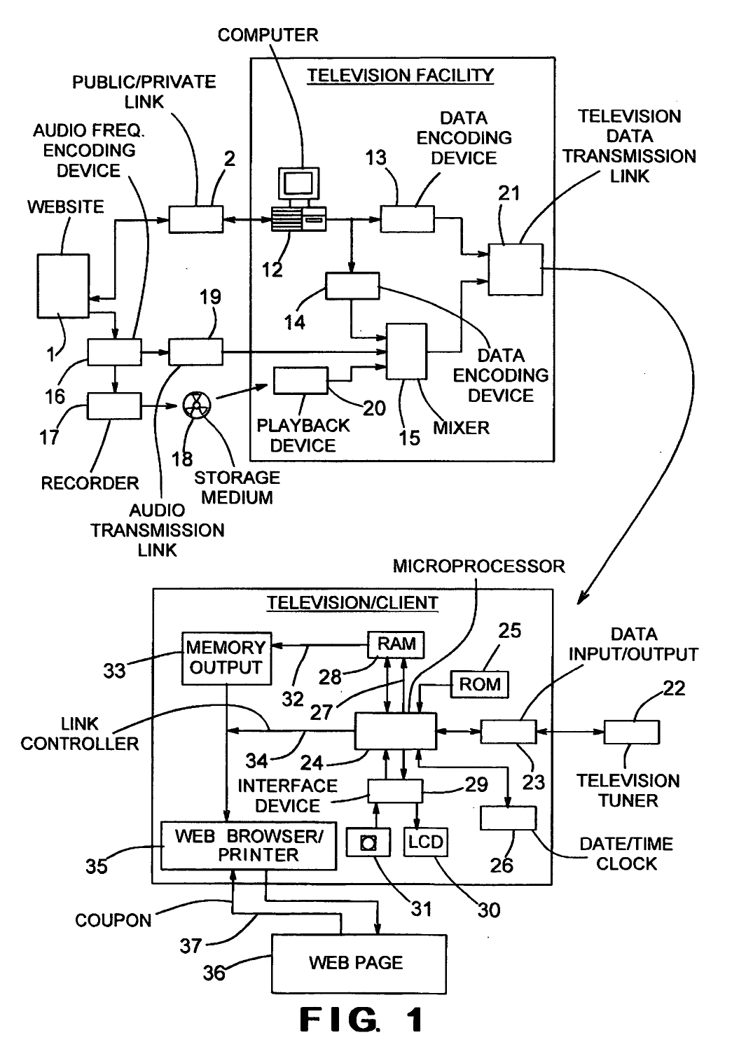

Referring to the FIG. 1, said program signal receiver apparatus may comprise a television receiver apparatus, a radio receiver apparatus and/or a media player apparatus. Said program signal receiving means may comprise tuner means, i.e. TELEVISION TUNER 22. TELEVISION TUNER 22 may receive said URL string transmitted via TELEVISION DATA TRANSMISSION LINK 21. Said program signal receiving means 22 may comprise any video or audio program receiver means such as broadcast, cable or satellite television or radio tuner means, the WebTV.TM. Internet Terminal available from Microsoft Corporation, Redmond, Wash. or WebTV Networks Inc., Palo Alto, Calif., set-top box means, Internet program signal receiver means or other program signal receiver means. In another embodiment, said program signal receiving means 22 may comprise storage medium means such as video or audio recorder or player means.

Via DATA INPUT/OUTPUT 23, said URL string may be input to MICROPROCESSOR 24 (which may comprise any conventional data processor, microprocessor, central processing unit or equivalent data processing means). ROM 25 may store the program of instructions which controls MICROPROCESSOR 24. Responsive to <text>Al's Formal Wear Coupon</text> 9A, MICROPROCESSOR 24 may route URL from <area href=“http://www.alsformalwear.com/coupon.asp” shape=“rectangle” coords=“10,20,40,60”/> 6A via BUS 27 to be temporarily stored in RAM 28, route <text>Al's Formal Wear Coupon</text> 9A via INTERFACE DEVICE 29 to be displayed as non-hypertext or, optionally, “hyperlink text” via LCD 30 and detect the URL expiration date/time from begin=“indefinite” dur=“media” 7A. The term “hyperlink text” as used herein encompasses the meaning including hypertext conferred thereon in Boden, et al, U.S. Pat. No. 5,930,512, Nielsen, U.S. Pat. No. 6,199,071, Carroll, et al, U.S. Pat. No. 6,154,205 and Kato, U.S. Pat. No. 5,809,512, which are incorporated herein by reference.

Said apparatus may further comprise: time measuring means, i.e. DATE/TIME CLOCK 26, operably coupled to said data processing means MICROPROCESSOR 24 for said data processing means MICROPROCESSOR 24 to determine when a time referenced by an attribute included in said hyperlink address string transpires. In one preferred embodiment, said URL expiration date/time attribute 7 may be detected and compared by comparing means with current date/time information from DATE/TIME CLOCK 26 first before one or more other attributes in said URL string is processed to ascertain first if said URL remains valid. DATE/TIME CLOCK 26 and/or said comparing means may be remote from or built-into said apparatus such as disclosed in Danneels, U.S. Pat. No. 5,602,992 or Maturi, et al, U.S. Pat. No. 5,559,999, which are incorporated herein by reference.

Said apparatus may further comprise: memory means RAM 28 and visual display means LCD 30, both operably coupled to said data processing means MICROPROCESSOR 24 and collectively configured for said user-activating said hyperlink to said predetermined hyperlink address responsive to said user-activating attribute <text>Advertiser Coupon</text> 9A, said memory means RAM 28 for storing for predetermined time said predetermined hyperlink address specified in said first attribute <area href=“http://www.spotcoupons.com/Advertiser.asp” shape=“rectangle” coords=“10,20,40,60”/> 6A/B and said visual display means LCD 30 for visually displaying, optionally with a text blinking effects attribute, for predetermined time predetermined data <text>Advertiser Coupon</text> 9A to prompt said user-activating said hyperlink to said predetermined hyperlink address wherein <text>Advertiser Coupon</text> 9A serves as both said user-activating attribute and predetermined data for display, however, said predetermined data for display may be pre-stored as text or a graphic image in predetermined storage means in said apparatus, and user-activating means, i.e. PUSHBUTTON 31, operably coupled to said data processing means MICROPROCESSOR 24 for said user-activating said hyperlink to said predetermined hyperlink address.

If user-activating attribute <text>Advertiser Coupon</text> 9A is received in said URL string, an hyperlink to WEB PAGE 35 may be user-activated via PUSHBUTTON 31. Visual display means such as LCD 30 may be used to alert an user that user activation of said hyperlink is available to be made. LCD 30, for example, may visually display “[Advertiser Name] Coupon” as text or, optionally, hypertext from <text>Advertiser Coupon</text> 9A to inform viewers that an hyperlink to coupon WEB PAGE 35 is available. In the WebTV.TM. Internet Terminal embodiment disclosed herein LCD 30 may comprise a drop down panel that displays said text. In addition to indicating when program-related URL in <area href=“http:/twww.spotcoupons.com.asp?/Advertiser” shape=“rectangle” coords=“10,20,40,60”/> 6A is no longer valid, begin=“indefinite” dur=“media” 7A may specify a stop display time as well so that said display coincides with the time when coupon WEB PAGE 35 is available to be accessed.

LED or equivalent visual display means rather than LCD 30 may be used as said visual display means. In addition, user activation means other than PUSHBUTTON 31 may be used such as keypad or VRU. Activating PUSHBUTTON 31, directly or via remote control, may send a control signal to MICROPROCESSOR 24, which, in turn, may instruct RAM 28 to output the stored URL 6 via BUS 32 to MEMORY OUTPUT 33.

Both LCD 30 and PUSHBUTTON 31 may be built into a conventional remote control unit and communicably coupled to MICROPROCESSOR 24. INTERFACE DEVICE 29 may then connect to a conventional two-way infrared (IR) link coupled to said remote control unit to send and receive control signals.

A skin may included documents which define the visual and behavior aspects of a browser component to hyperlink to content based on association with said content. Skins with associated button attributes and trigger events may be created and downloaded to TELEVISION/CLIENT for Interface Device 29, specifically visual display 30, via the TEXT skin element, and PUSHBUTTON 31, via the BUTTON skin element, and behavior for user-activated hyperlinking. Further, said hyperlink address string may include XML script and files for displaying a text or graphic prompt and a button with added functionality for hyperlinking. Said XML data structure may include a skin definition file and may comprise text, art, script and media files to create new and different skin appearance, layouts and functionalities, all synchronized to associated program material. Optionally, a coupon may be defined in said art and text files using standard template structure and scant data capacity compared to that used for a coupon web page. Said hyperlink address string including said skin XML files may be processed via MICROPROCESSOR 22 having an XML parser. Each of the skin button attributes and respective name/value pairs may be coded in accordance with SMIL coding.

Upon detecting said second attribute comprising said user-activating attribute 9A, MICROPROCESSOR 22 having XML parser routes URL http://www.spotcoupons.com.asp?Advertiser 6A to RAM 28 to be stored for predetermined time and text file <text>Advertiser Coupon</text> 9A is routed to skin TEXT element LCD 30 for display for predetermined time. User activation, depressing BUTTON element PUSHBUTTON 31 then causes URL http://www.spotcoupons.com.asp/Advertiser 6A to be outputted from RAM 28 via MEMORY OUTPUT 33 to web browser means in WEB BROWSER/PRINTER 35 to establish an hyperlink to WEB PAGE 36. Responsive to automatic activating attribute actuate=“on Load” 9B, MICROPROCESSOR 22 having XML parser inputs URL http://www.spotcoupons.com.asp?/Advertiser 6B direct to LINK CONTROLLER 34 to web browser means in WEB BROWSER/PRINTER 35 to establish an hyperlink to WEB PAGE 36. While the steps disclosed herein can be implemented by any suitable hardware, said steps utlilizing skin attributes encoded in SMIL URL STRING may alternatively be implemented in software.

The system disclosed herein may create a skin for TELEVISION/CLIENT, said skin including button attributes for one or more buttons comprising graphics associated with a portion of INTERFACE DEVICE 29 and skin hyperlink triggers may be programmed to be automatically activated via LINK CONTROLLER 34. Further included in said system may be downloading the one or more buttons, preferably in SMIL URL STRING, to TELEVISION/CLIENT. One or more buttons rather than the entire skin may be downloaded. For example, a downloaded skin button associated with a spot may be include text linked to the advertiser's web page containing a coupon for an advertised product or service. A downloaded skin button may alternatively be associated with non-commercial program material and include text linked to a web page containing a coupon for a product or service offered by a program sponsor.

Responsive to actuate=“on Load” 9B, MICROPROCESSOR 24 may route URL from <area href=“http://www.spotcoupons.com.asp?/Coupon” shape=“rectangle” coords=“10,20,40,60”t> 6B via BUS 27 to LINK CONTROLLER 34 to automatically activate the URL hyperlink to WEB PAGE 36 at begin=“dd:hh:mm:ss.0¹⁻ⁿ” 7B. In addition, MICROPROCESSOR 24 may detect the URL expiration date/time from end=“dd:hh:mm:ss.0¹⁻ⁿ” 7B.

Upon said user-activated or automatic activation, an hyperlink to WEB PAGE 36 may be established via WEB BROWSER/PRINTER 35. Hyperlinked content may then be displayed on TELEVISION SCREEN (NOT SHOWN) at the specified shape=“rectangle” coords=“10,20,40,60” location. COUPON 37 may then be printed, optionally without user activation pursuant to, for example, an HTML instruction included in said URL string, via WEB BROWSER/PRINTER 35. If not automatic, once images are displayed on the screen, the user may press PRINT BUTTON(NOT SHOWN) at WEB BROWSER/PRINTER 35 to commence printing in order to print a certain displayed image.

In one embodiment disclosed herein, the printing routine may operate as follows: MICROPROCESSOR 24 notifies SCALAR UNIT (NOT SHOWN) that PRINT BUTTON(NOT SHOWN) has been pressed. When the notification that PRINT BUTTON(NOT SHOWN) was pressed is received, SCALAR UNIT (NOT SHOWN) sends a print instruction to PRINTER PRINT CONTROLLER (NOT SHOWN), retrieves frame image data stored in the PRINTER DISPLAY FRAME MEMORY (NOT SHOWN) and forwards this data to the frame memory and stores it therein and PRINTER ENGINE (NOT SHOWN) processes the data for printing.

In one preferred embodiment disclosed herein, COUPON 37 is displayed as skin with Scalable Vector Graphics (“SVG”-an XML language specified in http://www.w3.org/TR/SVG, which is incorporated herein by reference). In another embodiment disclosed herein a SMART CARD (NOT SHOWN) as disclosed in Britt, Jr., U.S. Pat. No. 6,141,678, White, et al, U.S. Pat. No. 4,119,114 and Nemirofsky, U.S. Pat. No. 5,907,350, which are incorporated herein by reference, may be coupled to COMMUNICATIONS DEVICE 35 to receive redeemable coupons.

In addition to automatic hyperlink activator, LINK CONTROLLER 34 may also serve as an hyperlink de-activator. For example, LINK CONTROLLER 34 may automatically de-activate an advertisement-related hyperlink to an advertiser coupon WEB PAGE 35 when the advertisement ends. In said embodiment, begin=“indefinite” dur=“media” 7A or begin=“dd:hh:mm:ss.0¹⁻ⁿ” end=“dd:hh:mm:ss.0¹⁻ⁿ” 7B may reference an automatic hyperlink de-activate HTML or XML instruction.

Clearly, numerous modifications and variations of the instant invention are possible in light of the above teachings. It is therefore understood that, within the scope and spirit of the claims made herein, the invention may be practiced otherwise than as specifically described herein and the invention may be modified in arrangement and detail without departing from such scope and spirit.

What is claimed is:

1. A system for generating an hyperlink address string associated with predetermined program material related to predetermined printable content including attributes and values for hyperlinking to said predetermined printable content and hyperlinking to said predetermined printable content during the playing of said predetermined program material wherein at least one attribute and value for hyperlinking is also used for printing comprising:
generating means for generating said hyperlink address string associated with said predetermined program material including:
a first attribute indicating a predetermined hyperlink address for hyperlinking to said predetermined printable content and
a second attribute indicating predetermined temporal behavior for said hyperlinking;
encoding means operably coupled to said generating means for encoding said hyperlink address string for transmission via program signal transmitting means;
said program signal transmitting means operably coupled to said encoding means for transmitting said hyperlink address string;
program signal receiving means operably coupled to said program signal transmitting means for receiving said hyperlink address string;
data processing means operably coupled to said program signal receiving means for processing said hyperlink address string in predetermined manner;
hyperlink means operably coupled to said data processing means for hyperlinking to said predetermined printable content during the playing of said predetermined program material and
printing means operably coupled to said data processing means for printing said predetermined printable content based on said predetermined temporal behavior for said hyperlinking indicated in said second attribute.

2. A method for generating an hyperlink address string associated with predetermined program material related to predetermined printable content including attributes and values for hyperlinking to said predetermined printable content and hyperlinking to said predetermined printable content during the playing of said predetermined program material wherein at least one attribute and value for hyperlinking is also used for printing including the step of:
generating via generating means said hyperlink address string associated with said predetermined program material including:
a first attribute indicating a predetermined hyperlink address for hyperlinking to said predetermined printable content and
a second attribute indicating predetermined temporal behavior for said hyperlinking.

3. A method according to claim 2 further including the step of:
entering via data entering means to database means operably coupled to said generating means:
said predetermined hyperlink address and
said predetermined temporal behavior for said hyperlinking.

4. A method according to claim 3 wherein
said predetermined hyperlink address comprises a local storage address.

5. A method according to claim 3 wherein
said predetermined hyperlink address comprises an Internet Web address.

6. A method according to claim 2 wherein
said hyperlink address string comprises an URL string and
said predetermined hyperlink address comprises an URL.

7. A method according to claim 2 wherein
said hyperlink address string further comprises an attribute indicating predetermined spatial aspects of said hyperlinking.

8. A method according to claim 2 wherein
said hyperlink address string further comprises an attribute indicating predetermined interactive aspects of said hyperlinking.

9. A method according to claims 2 and 3 wherein
said generating means and database means comprise a website and
said entering means comprise a client computer.

10. A method according to claim 2 further including the step of:
encoding said hyperlink address string for transmission with program signals representative of said predetermined program material.

11. A program signal receiver apparatus for playing program material including predetermined program material related to predetermined printable content, hyperlinking to said predetermined printable content during the playing of said predetermined program material and printing said predetermined printable content using at least one attribute and value for said hyperlinking comprising:
program signal receiving means operably coupled to said program signal transmitting means for receiving said hyperlink address string;
data processing means operably coupled to said program signal receiving means for processing said hyperlink address string in predetermined manner;
hyperlink means operably coupled to said data processing means for hyperlinking to said predetermined printable content during the playing of said predetermined program material and
printing means operably coupled to said data processing means for printing said predetermined printable content based on said predetermined temporal behavior for said hyperlinking indicated in said second attribute.

12. An apparatus according to claim 11 wherein
said program signal receiver apparatus comprises a television receiver apparatus.

13. An apparatus according to claim 11 wherein
said program signal receiver apparatus comprises a radio receiver apparatus.

14. An apparatus according to claim 11 wherein
said program signal receiver apparatus comprises a media player apparatus.

15. An apparatus according to claim 11 wherein said program signal receiving means comprises tuner means.

16. An apparatus according to claim 11 further comprising:
memory, visual display means and user-activating means, each operably coupled to said data processing means and collectively configured for user-activating said hyperlink to said predetermined printable content responsive to said second attribute,
said memory means for storing for predetermined time said predetermined hyperlink address indicated in said first attribute,
said visual display means for visually displaying for predetermined time predetermined data to prompt said user-activating said hyperlinking said hyperlink to said predetermined printable content and
said user-activating means for said user-activaing said hyperlink to said predetermined printable content.

17. An apparatus according to claim 11 further comprising:
automatic activating means, operably coupled to said data processing means and configured for automatically activating said hyperlink to said predetermined printable content responsive to said second attribute.

18. An apparatus according to claim 111 wherein
said predetermined hyperlink address comprises a local storage address.

19. An apparatus according to claim 11 wherein
said predetermined hyperlink address comprises an Internet Web address.

20. An apparatus according to claim 11 further comprising:
time measuring means operably coupled to said data processing means for said data processing means to determined when a time referenced by an attribute included in said hyperlink address string transpires.

21. An apparatus according to claim 11 wherein
said hyperlink means comprises Web browser means.
